(19) United States
(12) Patent Application Publication
(10) Pub. No.: US 2007/0250415 A1
(43) Pub. Date: Oct. 25, 2007

(54) Vehicle body restoration process

(76) Inventor: Ronald Ridgeway Wilch, Placentia, CA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/242,143

(22) Filed: Sep. 12, 2002

Related U.S. Application Data
(60) Provisional application No. 60/318,714, filed on Sep. 13, 2001.

(51) Int. Cl. G06Q 50/00

(52) U.S. Cl. 705/29

(57) ABSTRACT

The present invention relates to a process for accurately estimating the cost of parts, materials, and labor units needed to properly restore a damaged vehicle body. The invention is directed to a vehicle body restoration process and vehicle body restoration guide used during the restoration process. The process includes entering an identification data for damaged areas of a vehicle on a stand alone computer or on a client computer in communication with a host computer wherein the identification data is based on a damage report supplied by an insurance company claims adjuster. A checklist is then retrieved from a material database on one or more body materials required for restoring the selected damaged areas. The body materials are utilized in restoring the damaged areas of the vehicle body and a list, such as an invoice of the body materials is generated.

### REFERENCE TO RELATED APPLICATION

This Application claims the benefit of U.S. Provisional Application No. 60/318,714 filed on Sep. 13, 2001.

### FIELD OF INVENTION

The present invention relates to a process for accurately estimating the cost of parts, materials, and labor units needed to properly restore a damaged vehicle body. The present invention can be used by collision repair shops for producing estimates and repair orders that more accurately identify the body materials, vehicle parts, and labor units required to properly repair the collision-damaged areas of a vehicle according to OEM and collision repair industry standards.

### BACKGROUND OF INVENTION

The restoration of a collision-damaged vehicle typically starts with a damage report or an estimate prepared by an estimator working for an insurance company. The damage report provides details of damage sustained, a listing of damaged areas to be replaced or repaired along with their costs and over-all cost of restoration the insurance would be willing to pay. Sometimes, the damage report may also include an estimate of the number and cost of labor units needed to complete the restoration. A collision shop typically utilizes the damage report as a “blueprint” in effectuating restoration of the damaged vehicle and as a cost guideline to keep track of and to compare the estimated overall cost of parts and labor units set forth in the damage report to the actual costs of parts and labor units utilized in making the necessary restoration. One of the problems associated with the current collision-damage repair process, however, is the damage report's failure to identify various body materials needed to properly restore the collision-damaged areas. As a result, collision shops, to realize reasonable minimal profits, sometimes either do an inadequate job of vehicle restoration or shift costs to some other damaged areas. Since the estimated costs of restoration are typically not accurately reflected in the damage report, collision repair shops are forced to either inadequately restore the damaged areas of the vehicle, i.e., cut corners, or shift costs from a damaged area in which the restoration costs have been underestimated to a damaged area in which the restoration costs have been overestimated. Thus, to offset the costs of body materials not adequately listed in the damage report, collision repair shops use the “cost-shifting” gambit, such as adding unnecessary procedures or exaggerating labor units needed to properly make all required restorations. The increasing awareness of consumers and monitoring by the collision and insurance industries, however, is exerting more and more pressure on collision repair shops to either eliminate, or at least minimize, any “cost-shifting” practices. The present invention has been developed to assist the collision repair shops in combating the “cost shifting” practice by enabling them to generate a more accurate cost estimate required for properly restoring the damaged areas of the vehicle.

The present invention not only helps combat the problem of “cost-shifting” perpetrated by some collision repair shops but it also proactively assists the collision repair shops in minimizing or eliminating unfair business practices, such as adding unnecessary procedures or exaggerating labor units in one area to cover cost in other areas.

### STATEMENT OF INVENTION

The present invention is directed to a vehicle body restoration process comprising:

(a) entering an identification data for damaged areas of a vehicle on a computer wherein said identification data is based on a damage report;

(b) retrieving a checklist from a material database on one or more body materials required for restoring said damaged areas;

(c) utilizing said body materials from said checklist in restoring said damaged areas; and

(d) generating a list of said body materials.

The present invention is also directed to a vehicle body restoration process comprising:

(a) entering an identification data for damaged areas of a vehicle on a client computer in communication with a host computer wherein said identification data is based on a damage report;

(b) retrieving a checklist from a material database on one or more body materials required for restoring said damaged areas;

(c) utilizing said body materials from said checklist in restoring said damaged areas; and

(d) generating a list of said body materials.

The present invention is further directed to a vehicle body restoration process comprising:

(a) receiving from a client computer an identification data for damaged areas of a vehicle, said client computer being in communication with a host computer wherein said identification data is based on a damage report;

(b) retrieving a checklist from a material database stored on said host computer on one or more body materials required for restoring said damaged areas; and

(c) sending to said client computer said checklist required for restoring said damaged areas.

The present invention is also directed to a computer program product comprising:

a computer usable medium having computer readable program code means embodied therein for causing restoration of a vehicle body, said computer readable program code means comprising:

(a) computer readable program code devices configured to cause a computer to enter an identification data for damaged areas of said vehicle body on said computer wherein said identification data is based on a damage report;

(b) computer readable program code devices configured to cause said computer to retrieve a checklist from a material database on one or more body materials required for restoring said damaged areas; and

(c) computer readable program code devices configured to cause said computer to generate a list of said body materials from said checklist.

The present invention is also directed to a computer program product comprising:

a computer usable medium having computer readable program code means embodied therein for causing restoration of a vehicle body, said computer readable program code means comprising:

(a) computer readable program code devices configured to cause a host computer to receive from a client computer an identification data for damaged areas of a vehicle, said client computer being in communication with said host computer wherein said identification data is based on a damage report;

(b) computer readable program code devices configured to cause said host computer to retrieve a checklist from a material database stored on said host computer on one or more body materials required for restoring said damaged areas; and

(c) computer readable program code devices configured to cause said host computer to send to said client computer said checklist required for restoring said damaged areas.

### BRIEF DESCRIPTION OF DRAWINGS

FIGS. 1 though 30 illustrate the screen shots of a vehicle body restoration guide displayed on a stand-alone computer or a client computer during the process of the present invention.

FIG. 31 broadly illustrates the hardware involved in one embodiment of the process of the present invention.

FIG. 32 broadly illustrates the hardware involved in another embodiment of the process of the present invention.

FIG. 33 is a flowchart that broadly illustrates the steps taking place in the embodiment of the process of the present invention illustrated in FIG. 31.

FIGS. 34 though 42 illustrate the screen shots of a list in the form of invoices displayed on the stand-alone computer or the client computer during the process of the present invention.

FIG. 43 is a flowchart that broadly illustrates the steps taking place in another embodiment of the process of the present invention illustrated in FIG. 32.

### DETAILED DESCRIPTION OF PREFERRED EMBODIMENT

Unless stated otherwise:

“Restoration process” includes a process for repairing and/or repainting damaged vehicle body portions, such as dented areas of vehicle bodies; and/or removal and replacement of vehicle body parts, such as door hinges, window panes, windshields, door handles, grilles, lights, and various fasteners.

“Vehicle” includes an automobile, truck, semi-truck, tractor, motorcycle, trailer, ATV (All terrain vehicle), pick-up truck or a heavy mover, such as a bulldozer, mobile crane and earth movers.

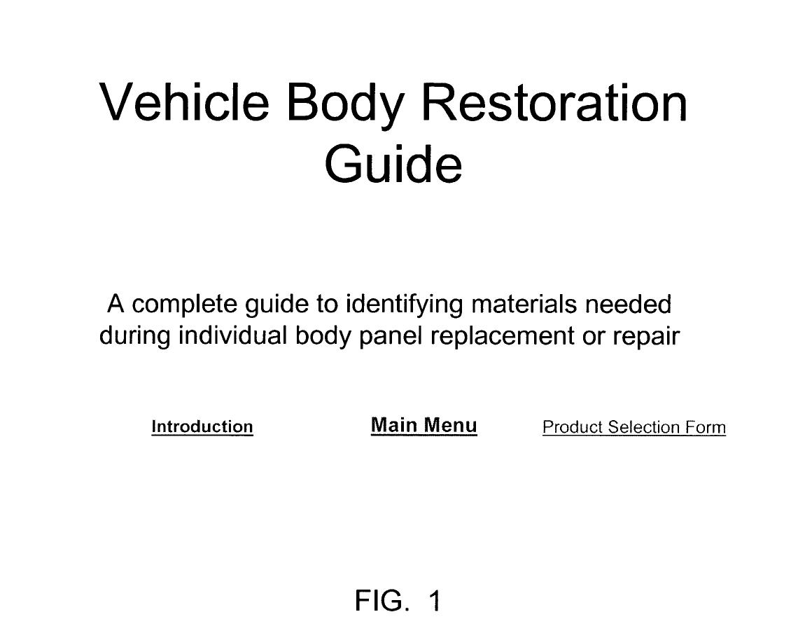

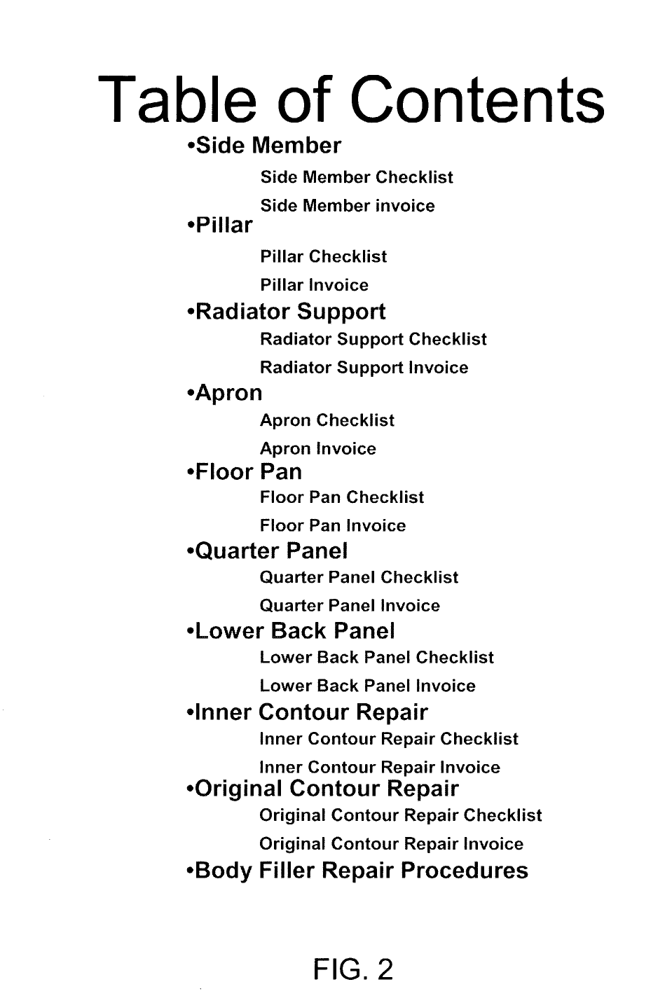

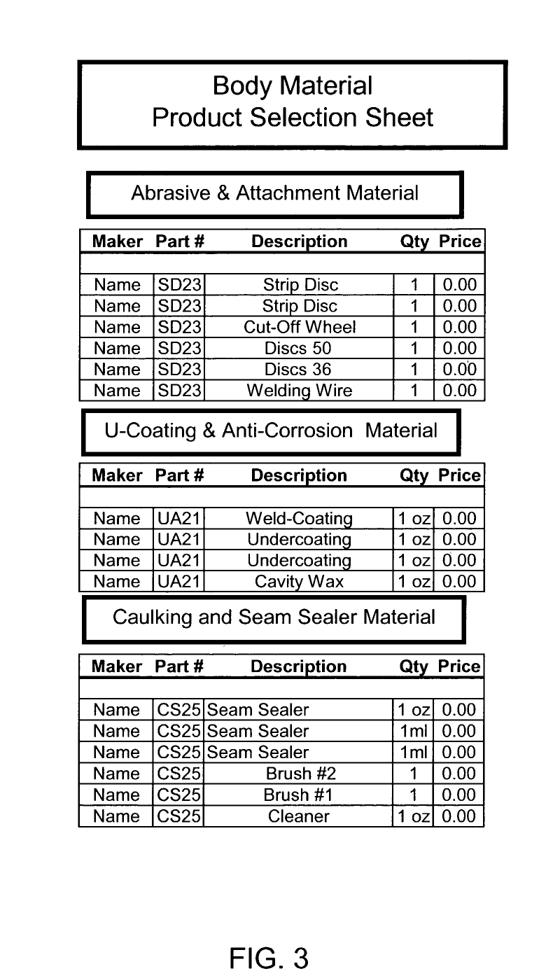

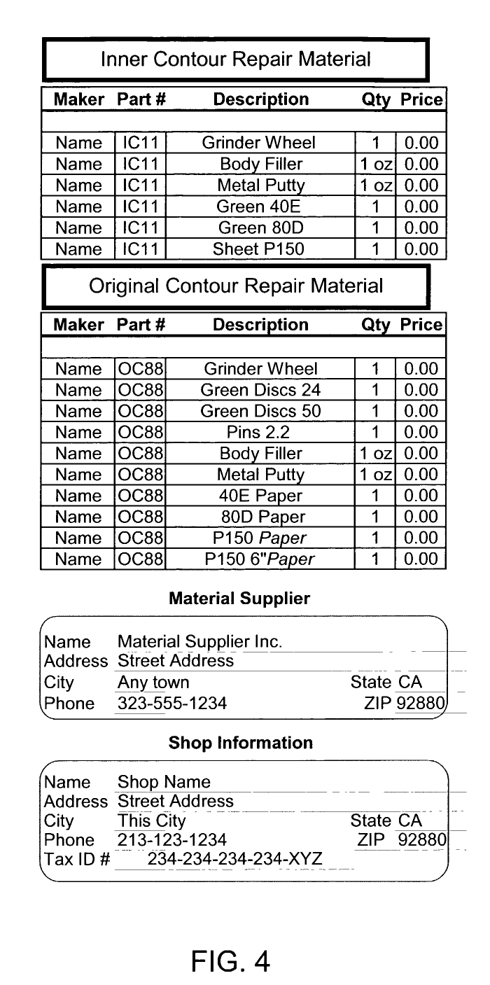

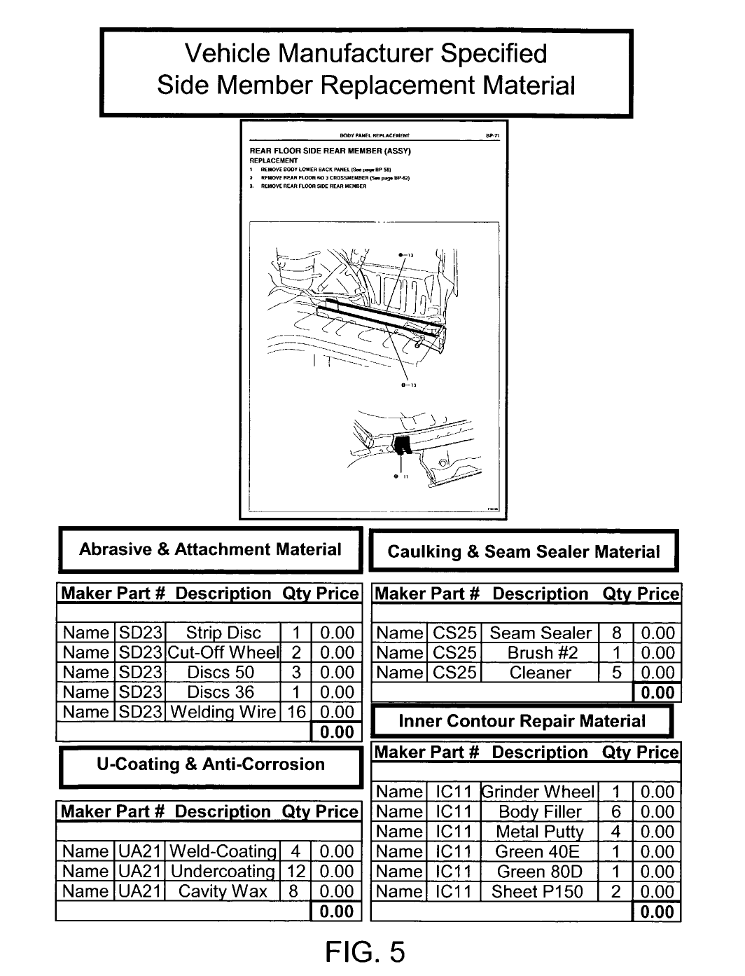

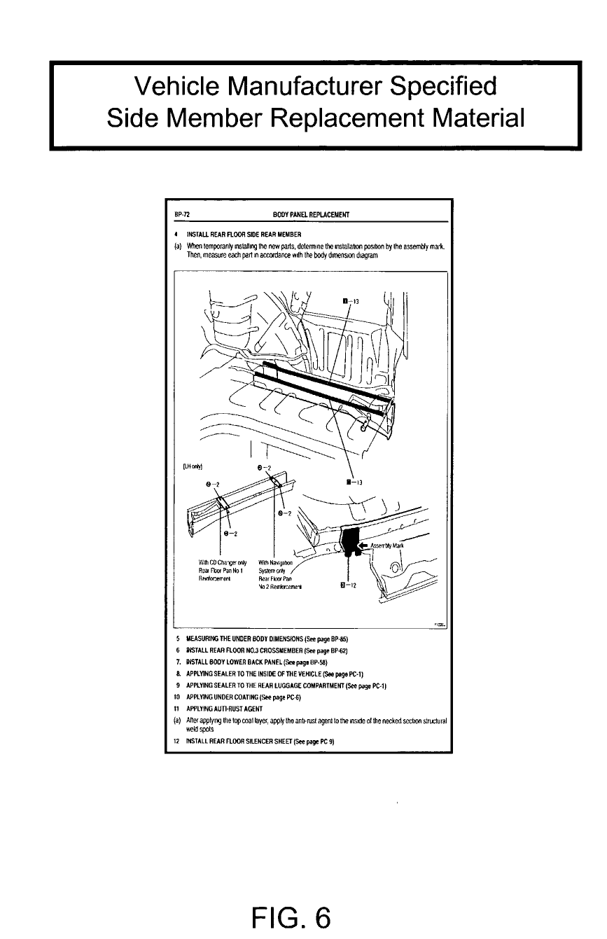

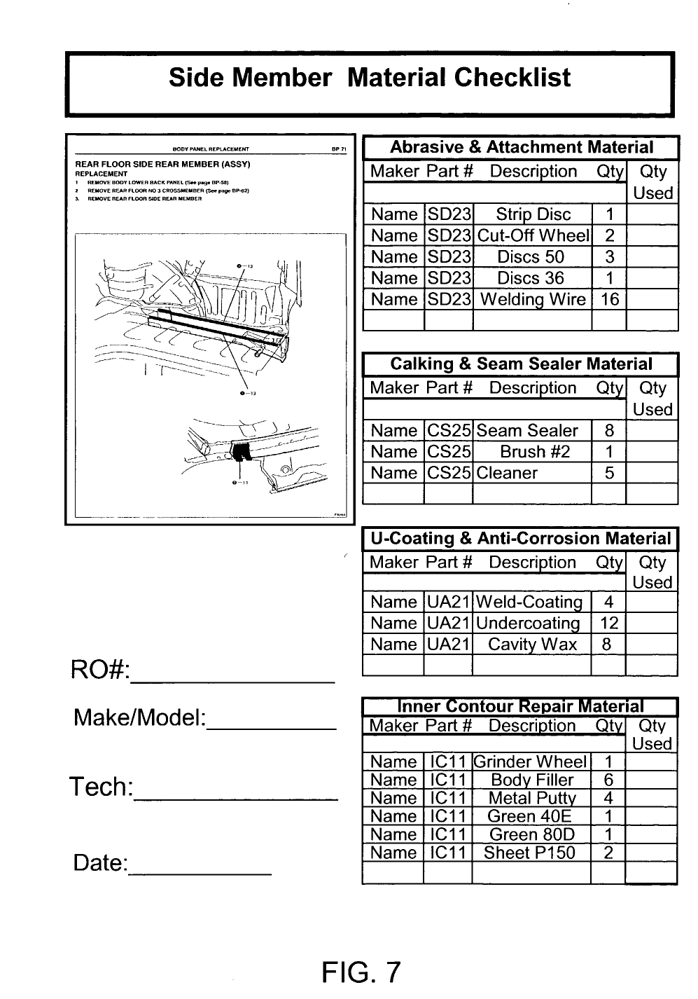

A computer program product of the present invention also known as a vehicle body restoration guide (FIGS. 1 through 30) can be used by a collision repair shop to identify and document the vehicle body materials that a body repair technician will need to repair and/or repaint damaged vehicle body portions and/or to replace individual body parts per industry and OEM (original equipment manufacturer) standards. The guide provides collision repair shops and their technicians with a single source for body material requirement data needed for a vehicle body restoration. The technician can use the guide for guidance on utilizing proper materials that should be used during the restoration process. When the guide is used to identify and document the body materials used during the repair, the customer or third party inspector can audit the repairs and verify that proper procedures and the necessary body materials were utilized and not overlooked. As a result, the customer can be assured that best and efficient business practices were employed at the least cost for producing a high quality vehicle restoration job.

The software for the guide can be produced by utilizing a conventional spreadsheet program, such as, for example, Microsoft Excel® spreadsheet or database program, such as, for example, Microsoft Access® database software, both supplied by Microsoft Corporation of Redmond, Wash.

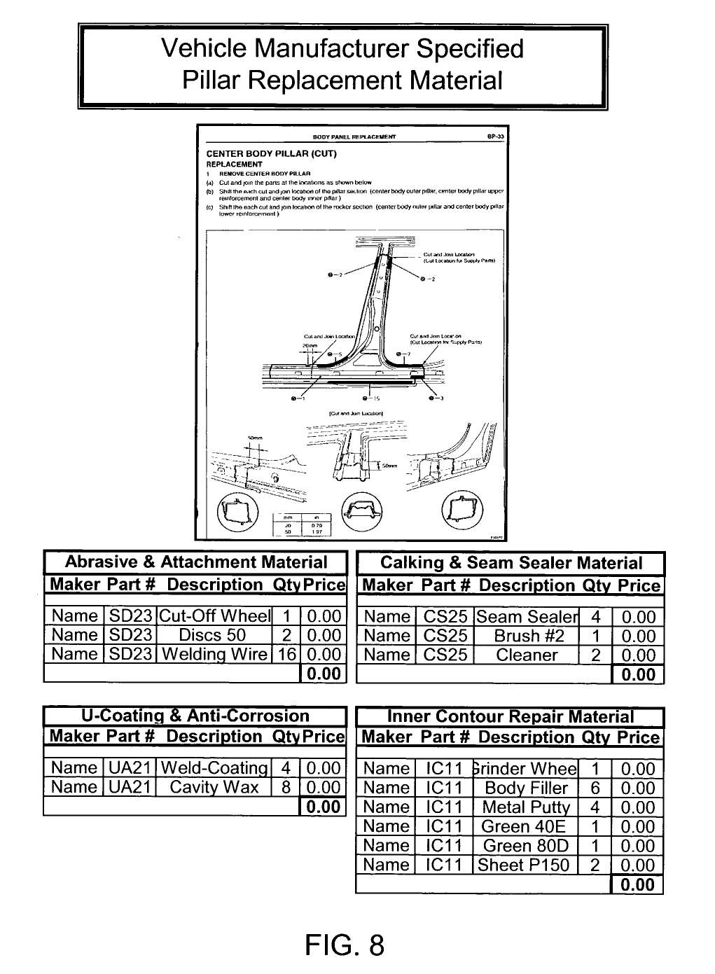

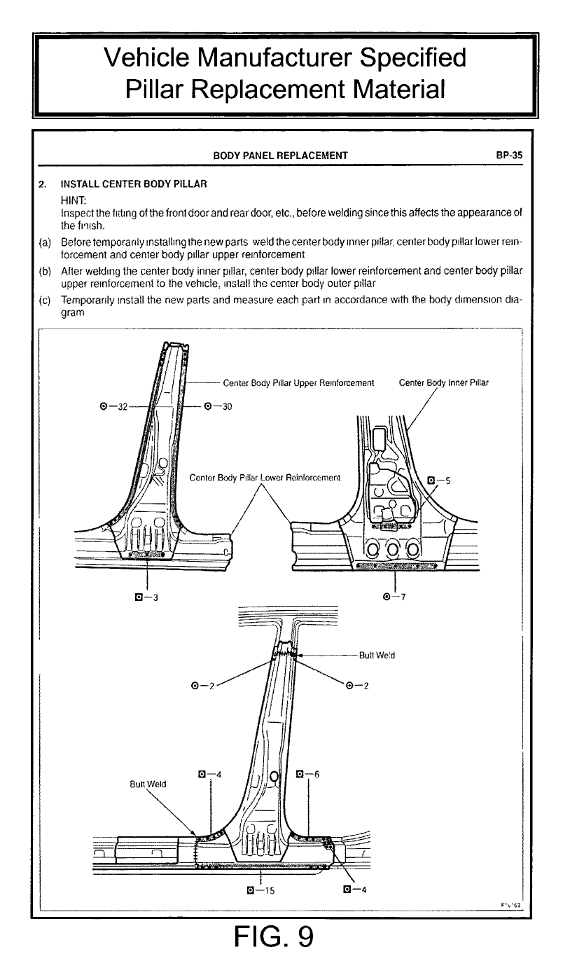

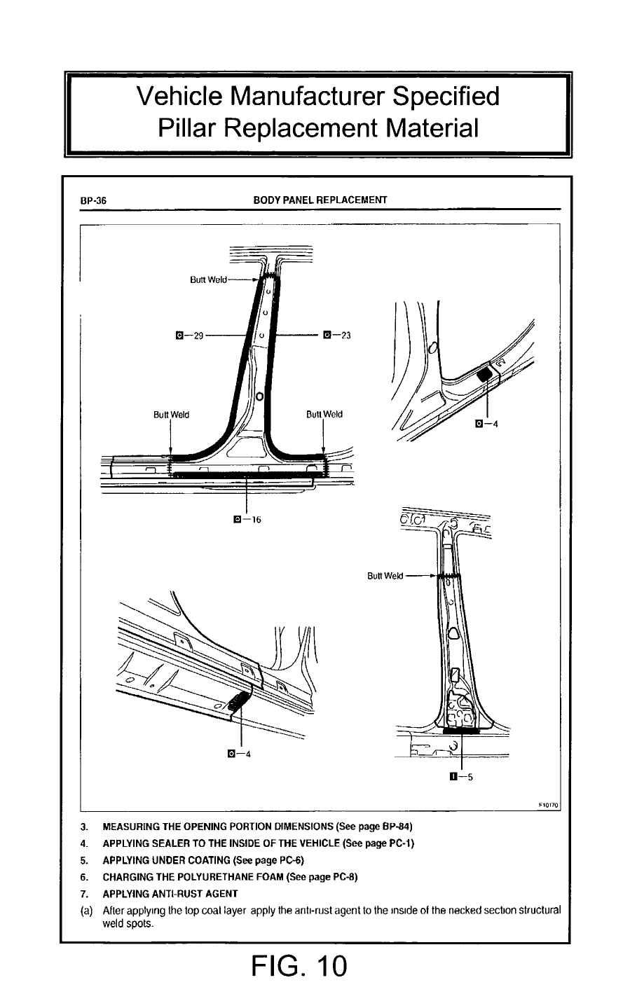

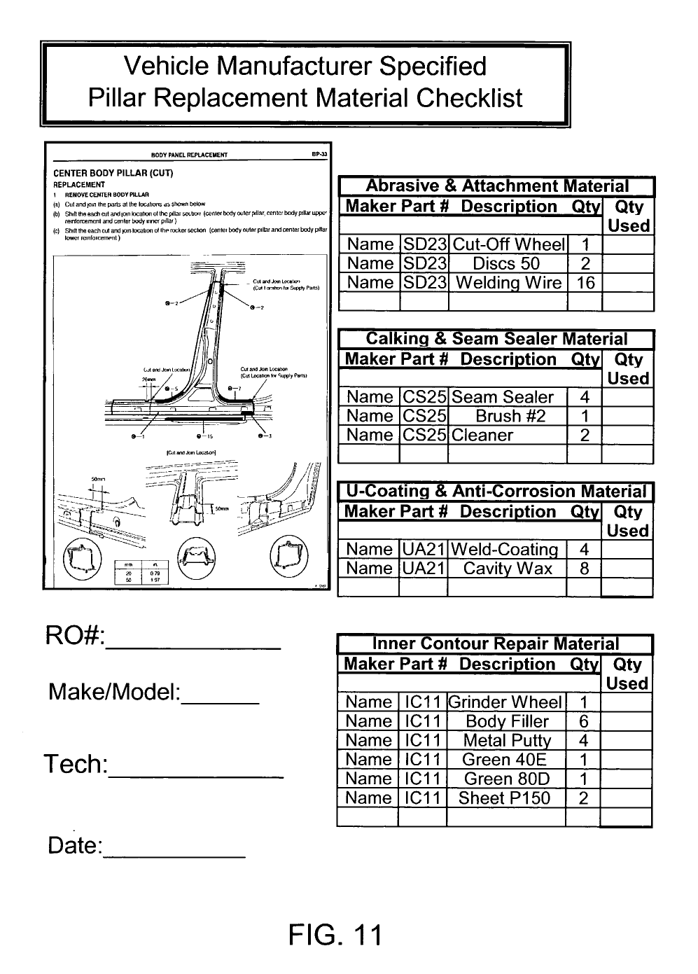

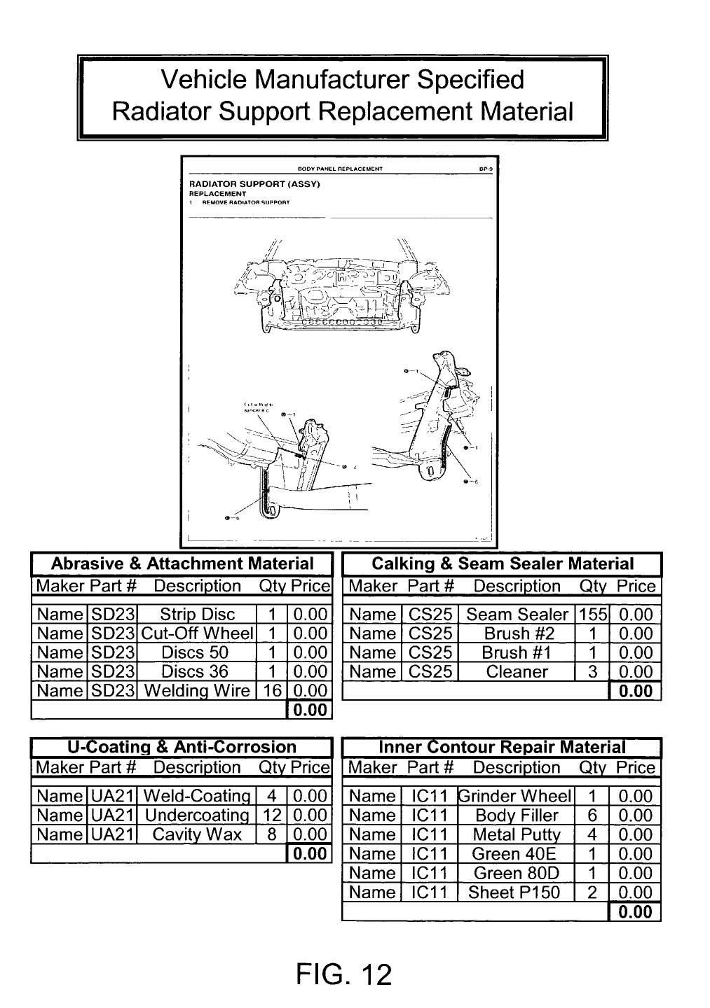

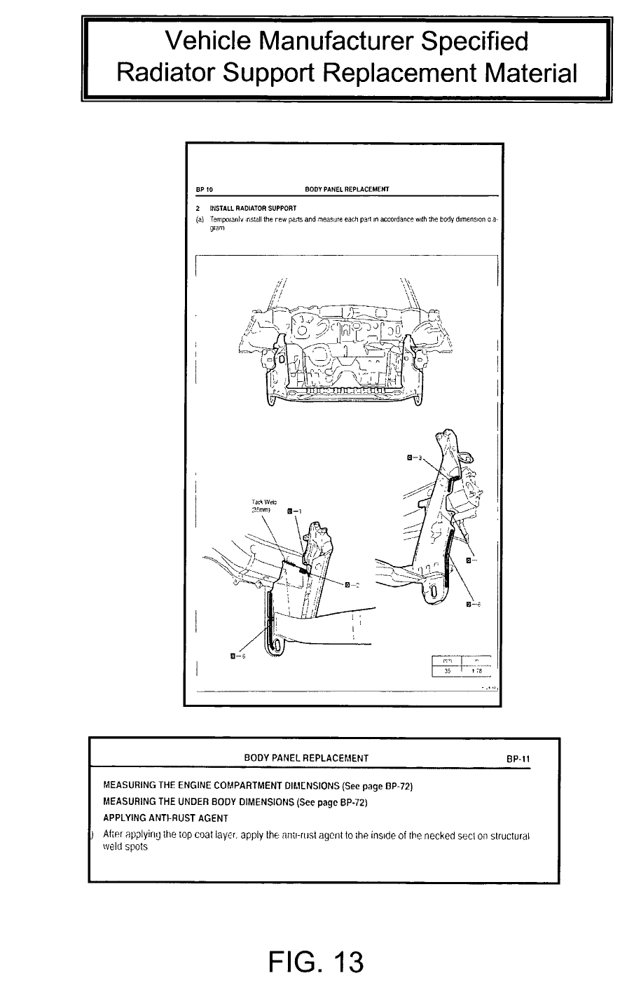

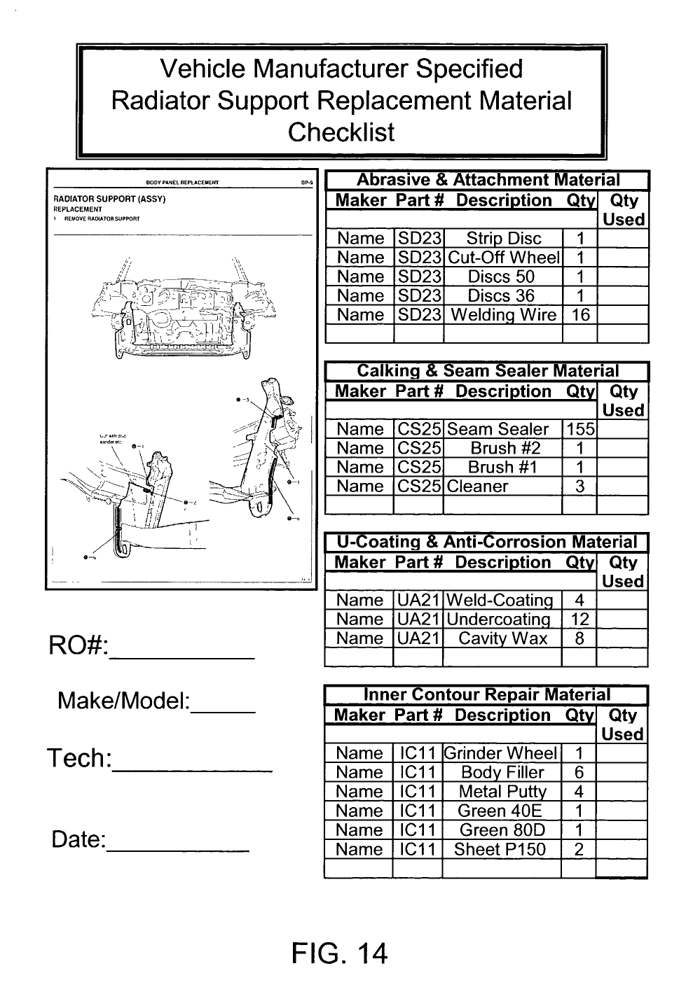

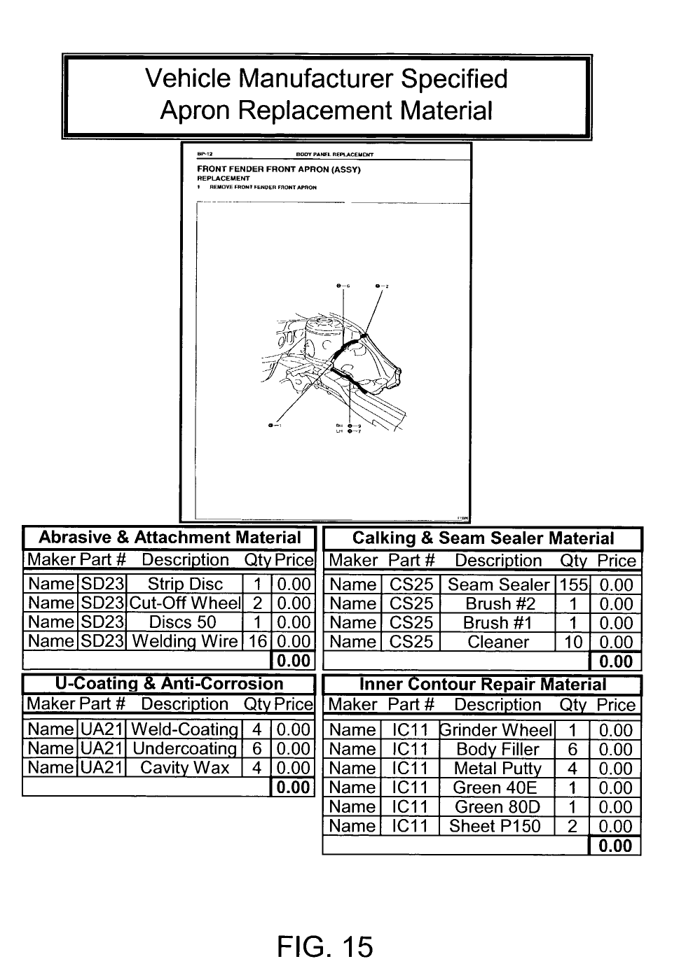

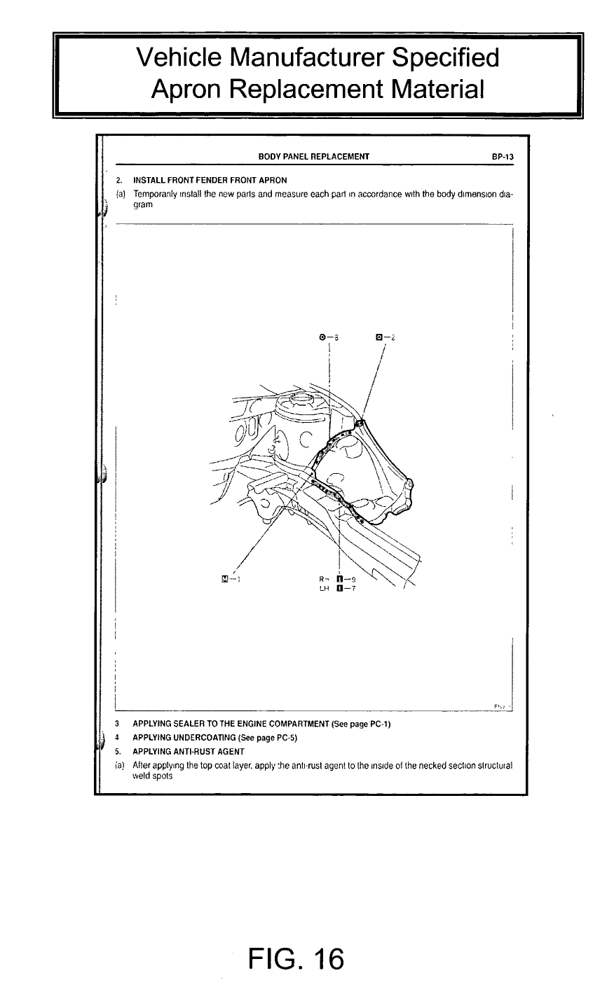

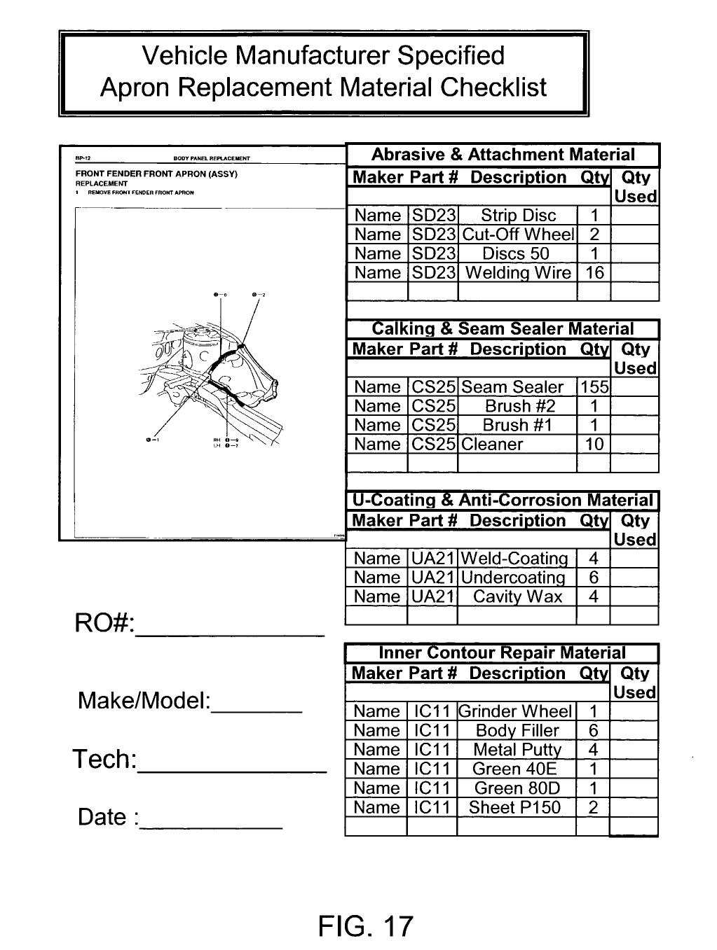

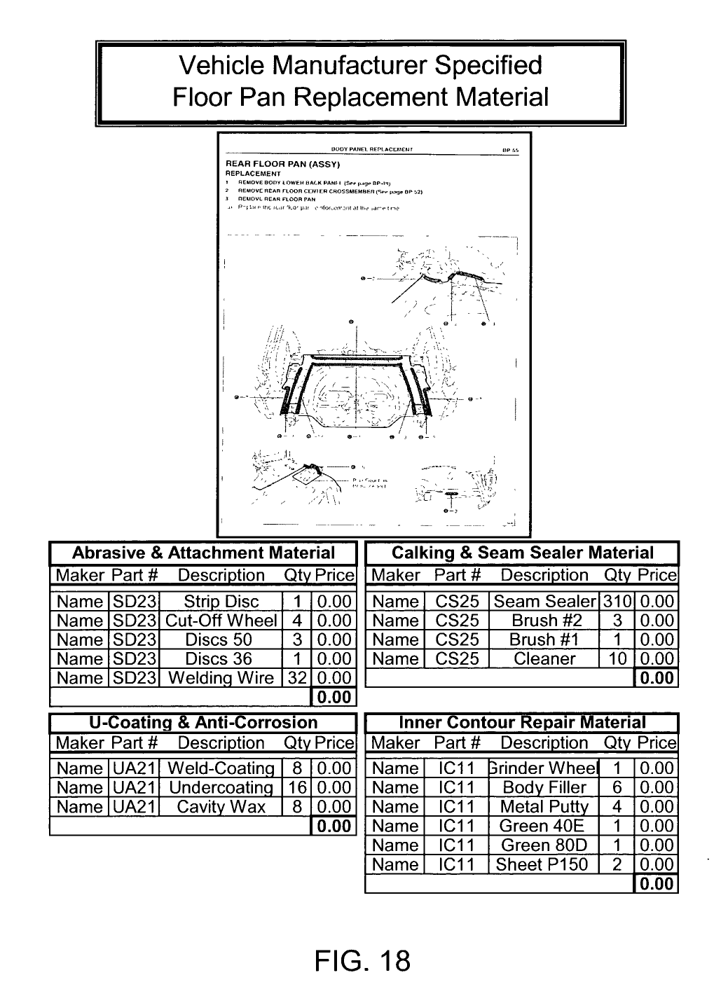

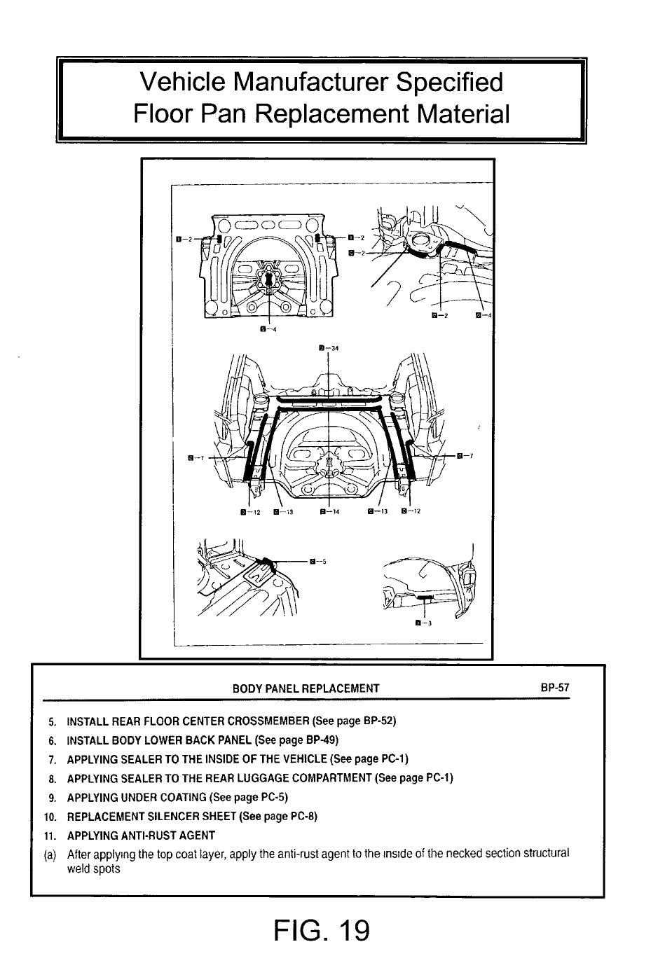

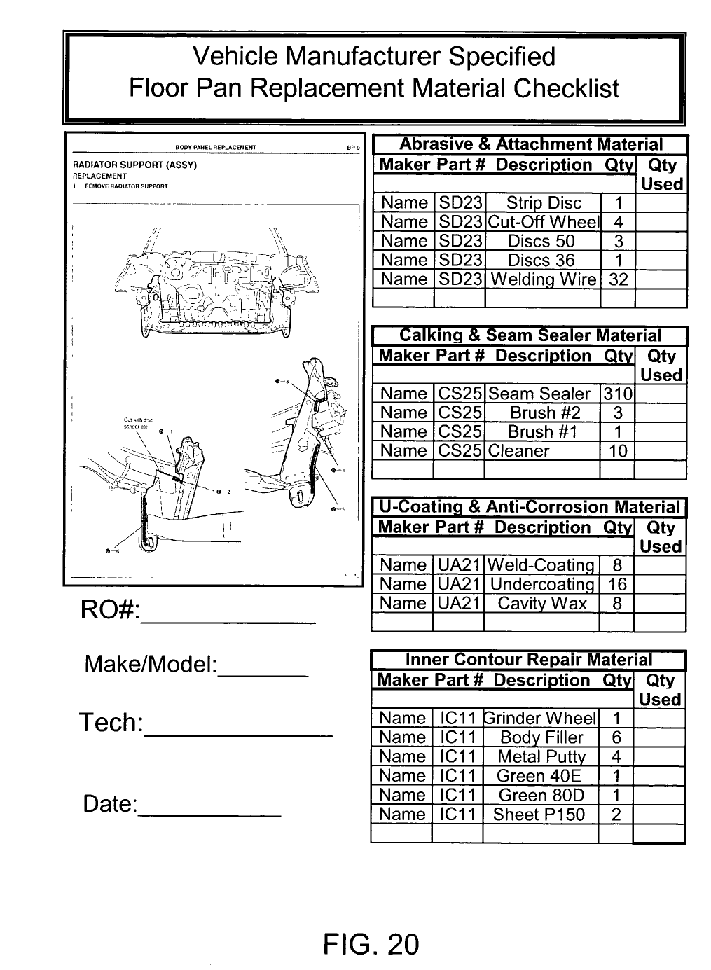

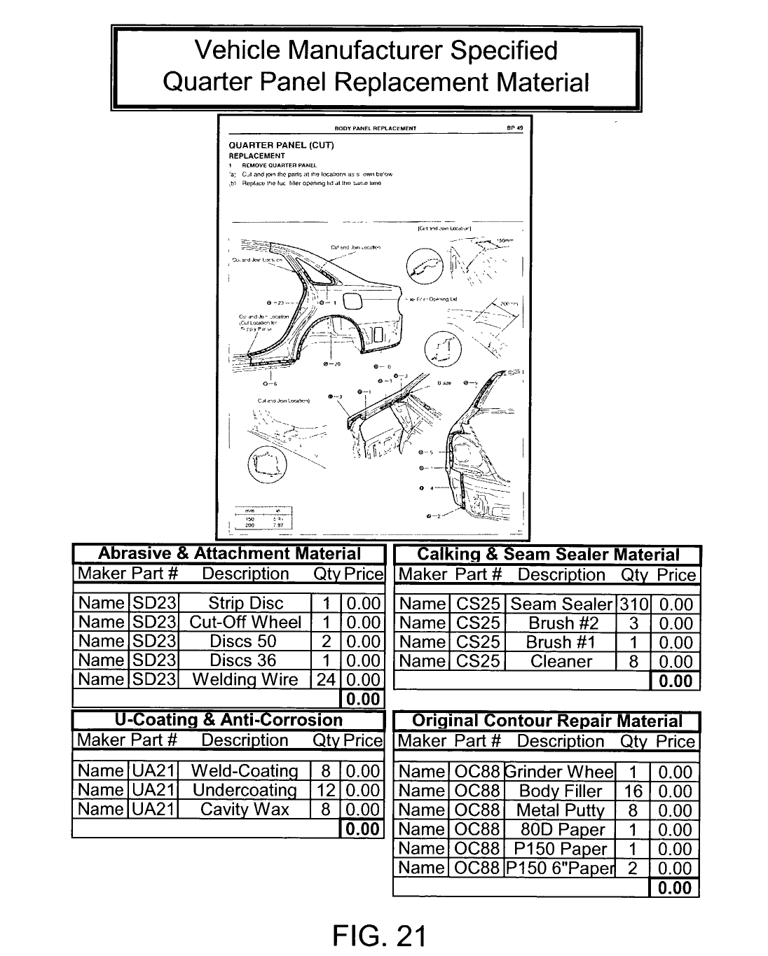

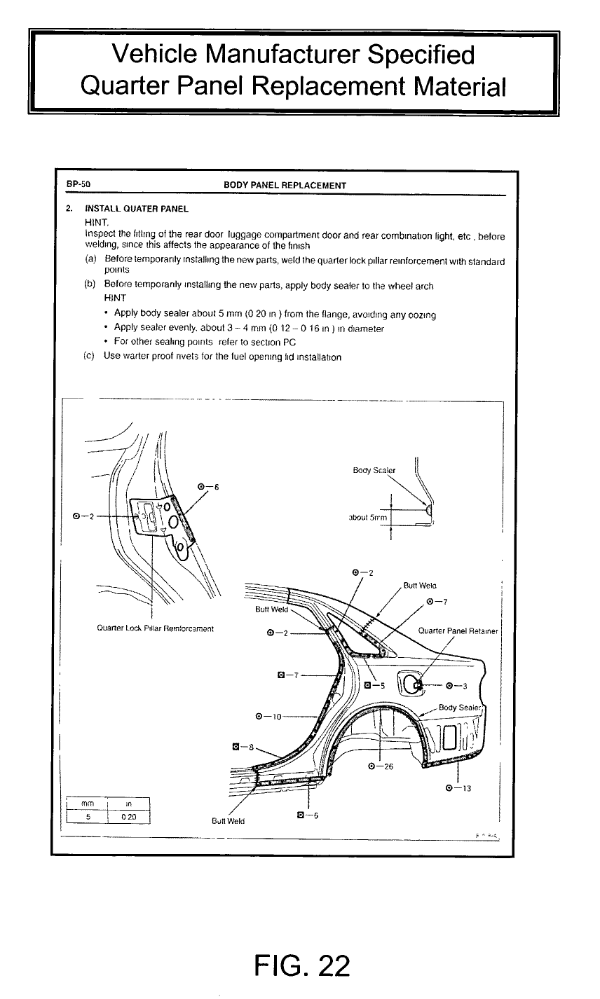

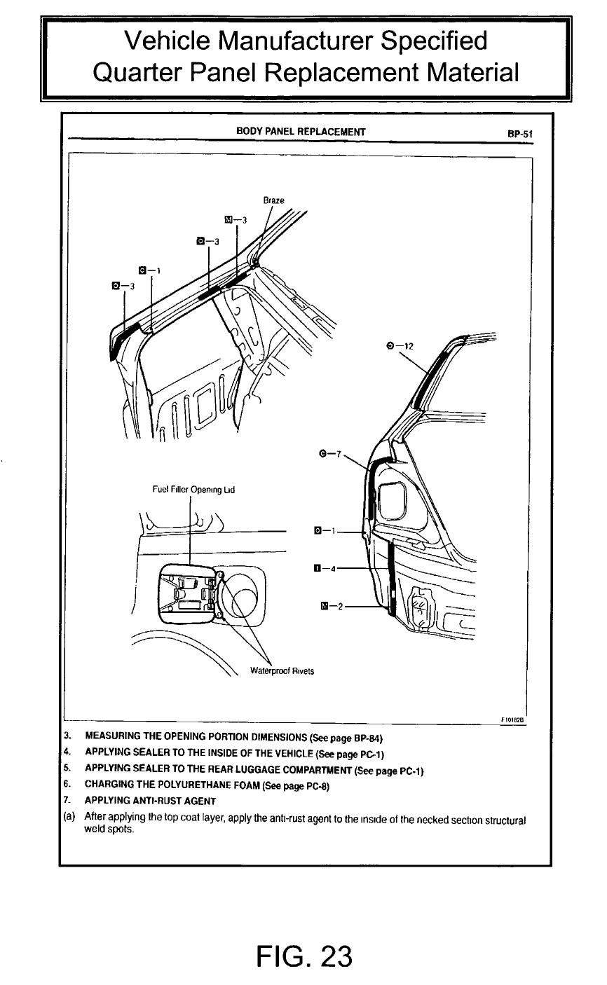

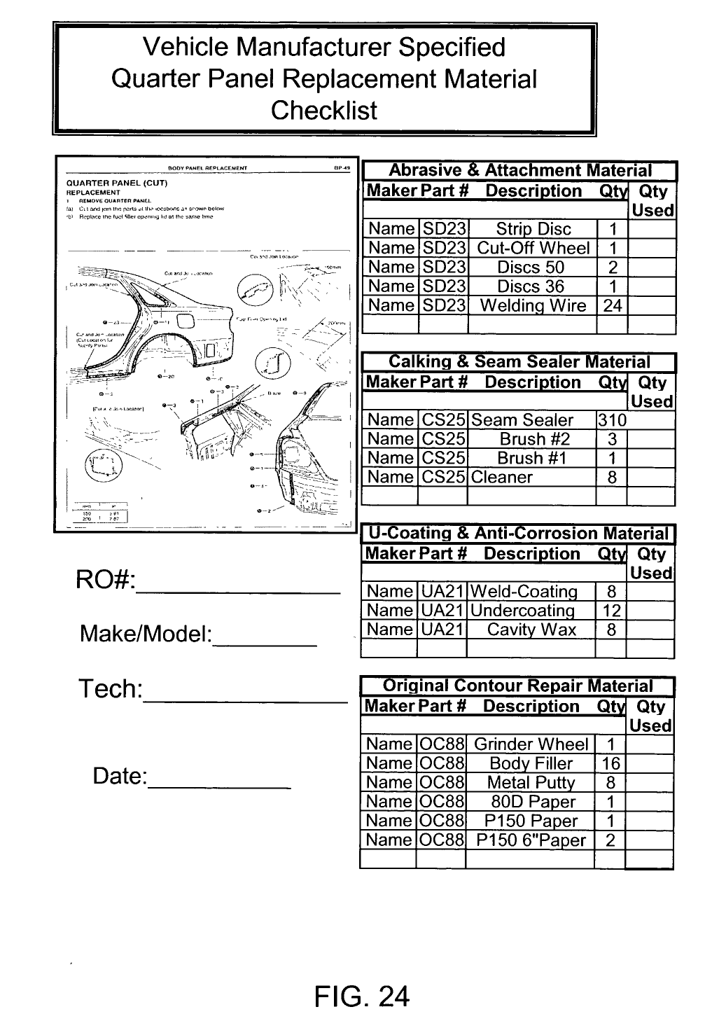

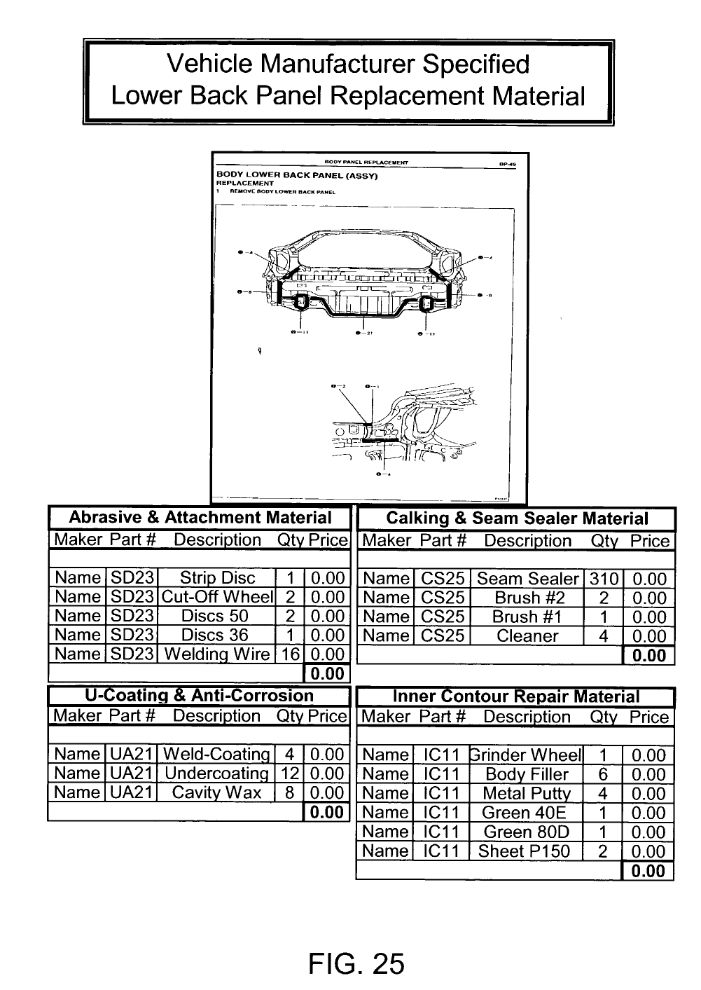

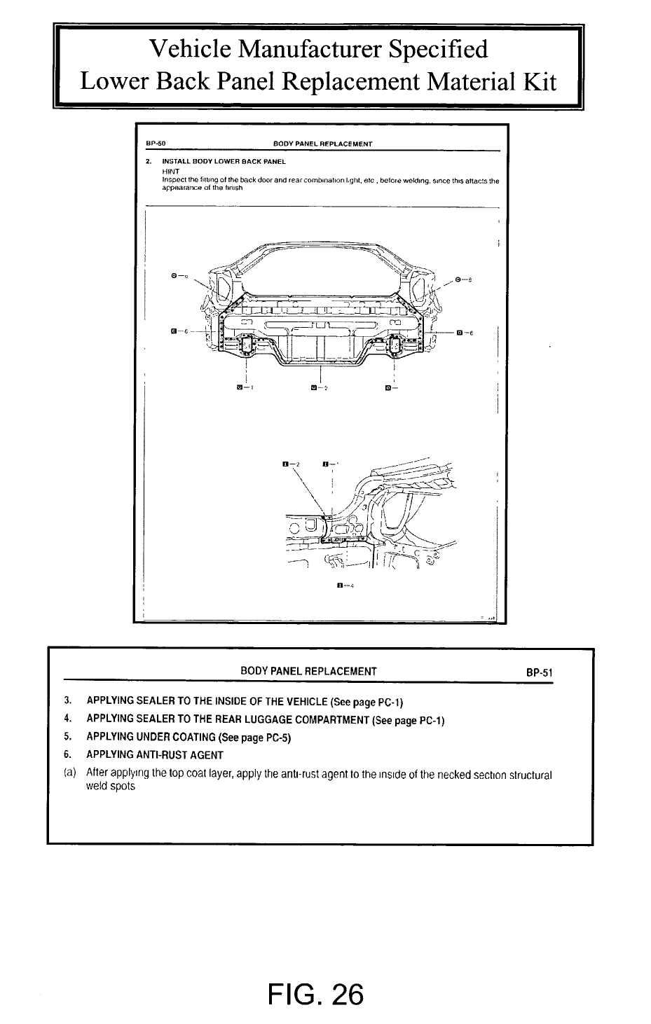

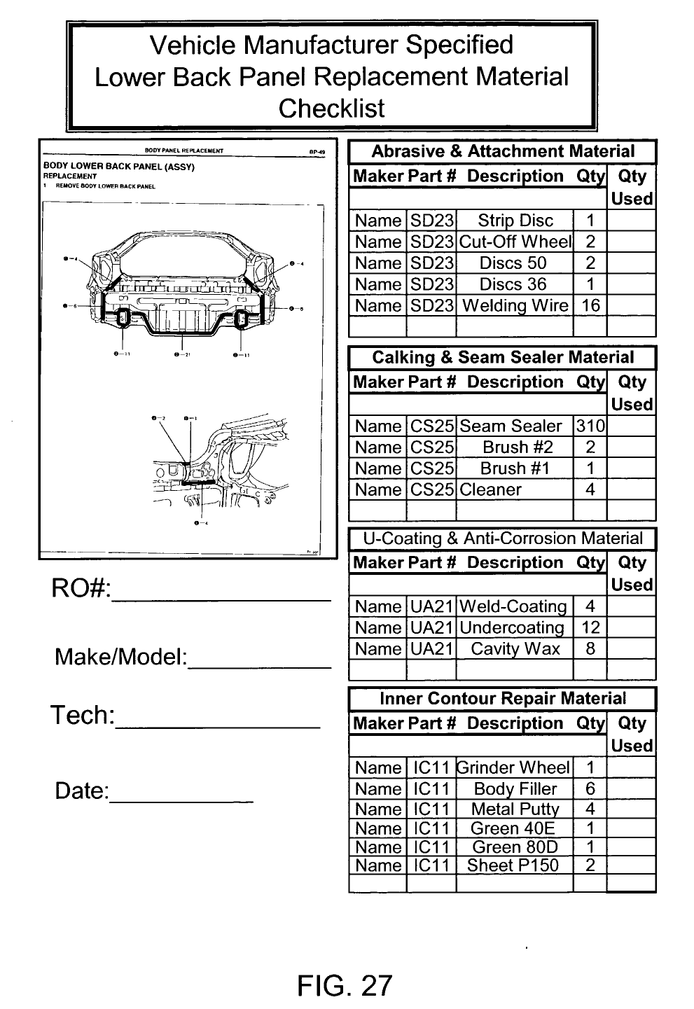

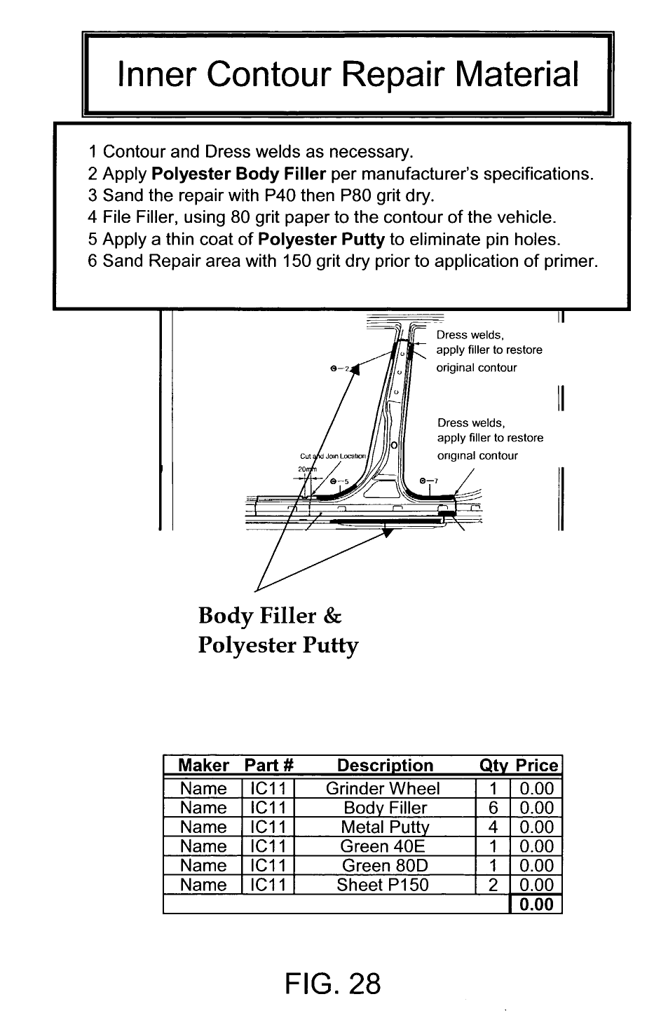

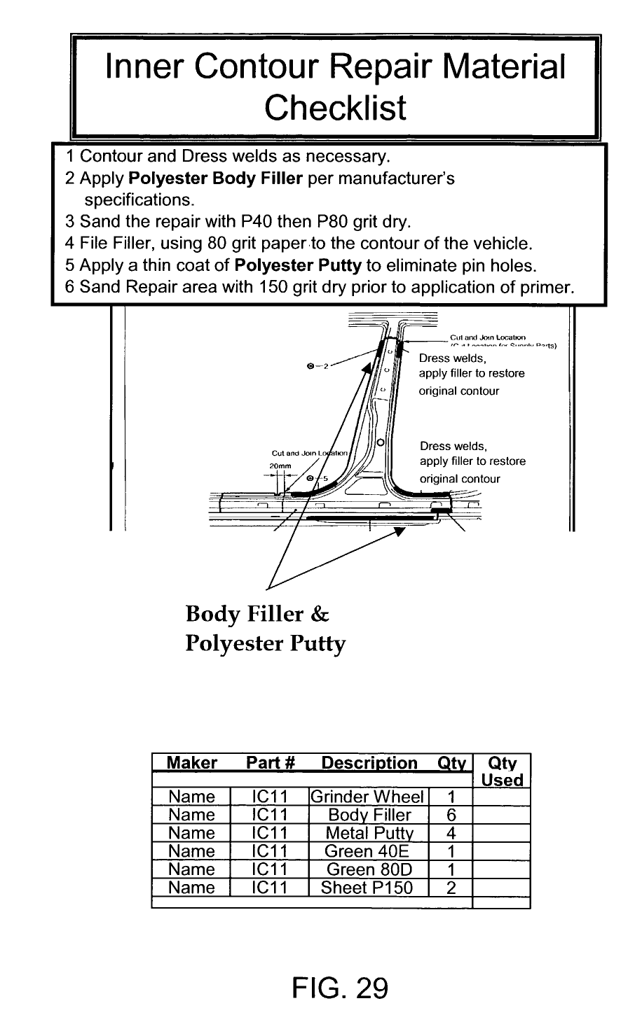

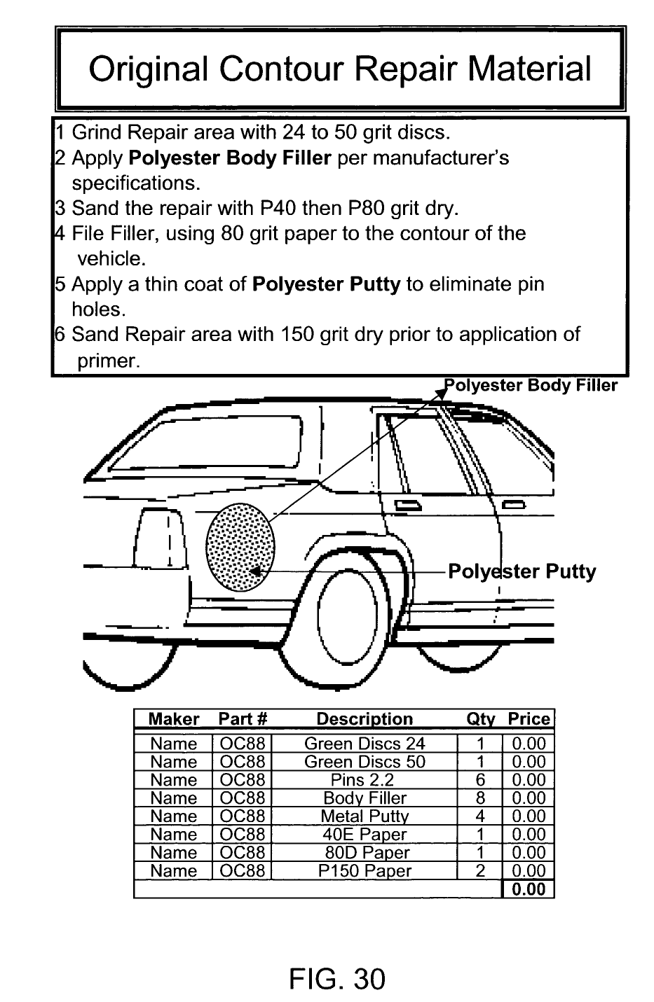

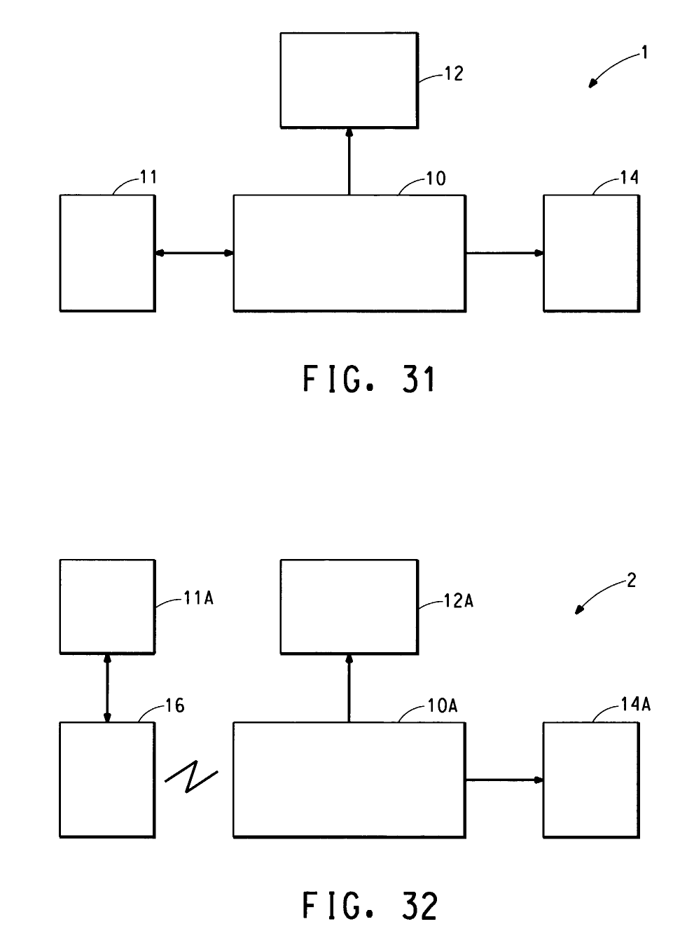

FIG. 31 shows the preferred embodiment 1 of the present invention wherein a conventional stand-alone computer 10 is connected to a display unit 12 and is optionally connected to a conventional printer 14. The vehicle body restoration guide of the present invention is preferably stored on a conventional memory storage device 11, such as, a floppy disc or CD-ROM. A user typically uploads the contents of memory storage device 11 into computer 10 during use by inserting memory storage device 11 into computer 10. If desired, the contents of storage device 11 can be uploaded into the hard drive of computer 10.

FIG. 32 shows another embodiment 2 of the present invention wherein a conventional client computer 10A is in communication, such as through a modem, with a host computer 16. Client computer 10A is connected to a display unit 12A and optionally connected to a conventional printer 14A. The vehicle body restoration guide of the present invention is preferably stored on a conventional memory storage device 11A, such as, a floppy disc or CD-ROM. The contents of storage device 11A are uploaded into host computer 16 or can be accessed through host computer 16 during the use. Client computer IOA then accesses the contents of storage device 11A by communicating with host computer 16.

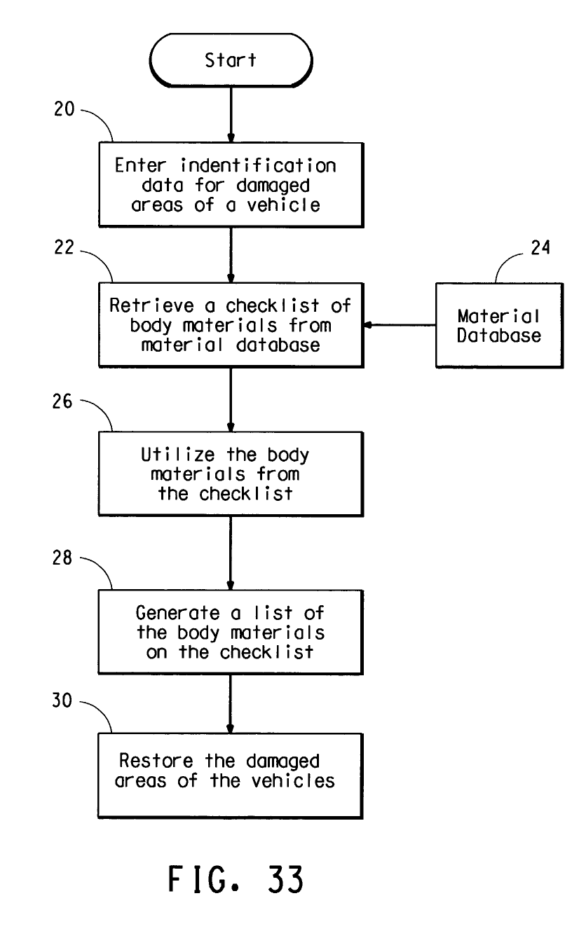

FIG. 33 illustrates the steps used in a vehicle body restoration process of the present invention:

In a step 20 an identification data for damaged areas of a vehicle are entered on computer 10 or client computer 10A, which is in communication with host computer 16. The identification data is based on a damage report typically prepared by an adjuster from an auto insurance company. The adjuster typically inspects the damaged vehicle and then prepares the damage report. The adjuster generally relies on her work experience and on the technical and pricing information supplied by vehicle OEMs and insurance companies in preparing the damage report. The damage report details the extent of the damage and lists the damaged areas. If desired, the damaged report can be also produced by accessing an estimator database that catalogs the various body areas of a vehicle identified by make, year and model number of the vehicle as well as various restoration costs associated with typical vehicle damage. The damage report can also include estimated labor units needed for restoring the damaged areas and the total cost of the restoration the insurance company would be willing to pay. If desired, the damaged report could be stored on computer 10, client computer 10A or on host computer 16 for future use and reference.

FIG. 2 of the guide lists typically damage areas, such as, for example, a side member, pillar, radiator support, apron, floor pan, quarter panel, lower back panel, inner and outer contoured portions of a vehicle. By clicking on any of the damage area listed in FIG. 2, such as, for example, side member, the user is linked to the vehicle manufacturer specified information regarding the side member, such as that shown in FIGS. 5-6.

In a step 22, a checklist of the typical body materials required to properly restore the selected damage area, such as the side member shown in FIGS. 5-6, is retrieved from a material database 24 of the vehicle body restoration guide. Typically, the material database, which is part of the guide, resides on a CD-ROM loaded into computer 10, a hard drive of computer 10 or on host computer 16. The checklist typically includes one or more body materials required for restoring said damaged areas. Some of the examples of the body materials, listed in FIGS. 3 and 4, include abrasive & attachment materials; undercoating & anti-corrosion materials; caulking & seam materials; and inner & outer contour portion repair materials. Most of these materials are available from 3M corporation located in Saint Paul, Minn. It should be understood that the process of the present invention could include one or more of the aforementioned body materials. Thus, the checklist provides the technician with the body materials that are not provided in the damage report.

In a step 26, the body materials listed in the checklist are utilized in restoring the damaged areas, such as, for example, the side member described in FIG. 7. The term “utilizing” means gathering and providing the technician with all the required body materials to complete the vehicle restoration. The checklist, as seen in FIG. 7, typically includes quantity, cost and manufacturer of the body materials required for restoring the damaged areas. Thus, by utilizing the procedure and materials on the checklist, which is based on the manufacturer's recommendations, the restoration can be performed in accordance with the proper procedures. As a result, the quality of the restoration can be ensured and the right amount of required body materials are used in the restoration the damaged areas of the vehicle. The technician enters on the checklist displayed on the screen of display unit 12 the relevant information regarding the repair, such as repair order number, the date the work was performed, the make and the model of the damaged vehicle being restored. The checklist also includes visual instructions suitable for carrying out the restoration of the damaged areas.

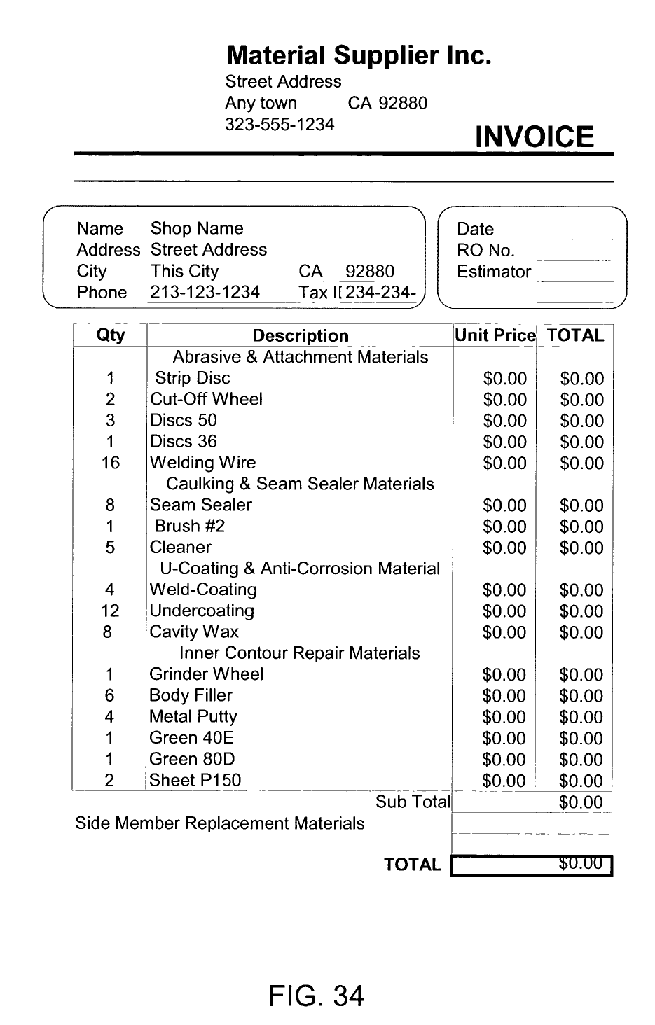

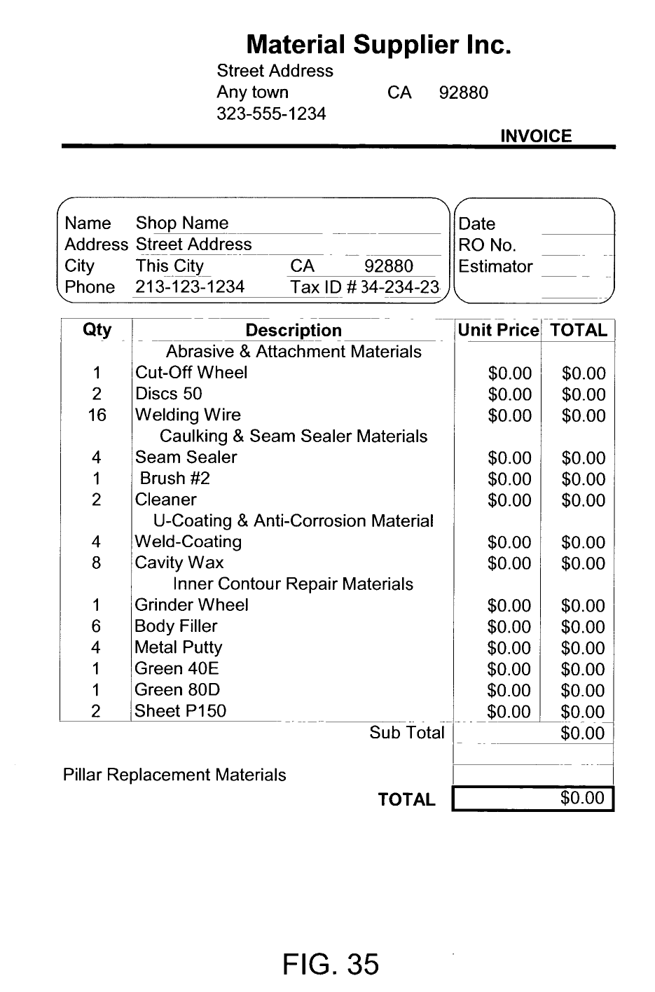

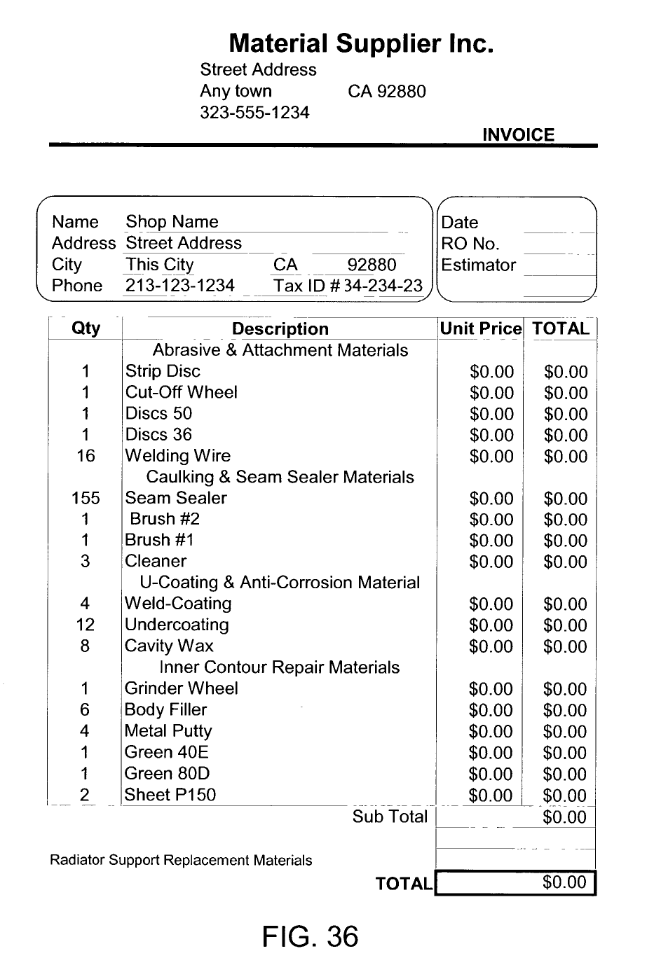

In a step 28, a list of said body materials that are to be utilized in restoring the damaged areas is generated. Such a list can be seen in FIGS. 34 through 42. Generally, the list is in the form of an invoice. Thus, if the insurance company or appropriate state authority conducts the audit of the collision repair shop, shop manager can readily generate the invoice and logically explain the restoration charges submitted to the insurance company. If desired, the list can further include the identity of the technician and the number of labor units used in restoring damaged areas of the vehicle. Furthermore, the list can also assist the shop manager in establishing that no cost shifting took place in completing the vehicle restoration. If desired, the list can be printed on a printable sheet, such as paper sheet, through printer 14 or stored on the hard drive of computer 10 or on an independent server for future reference and use.

The process of the present invention can further include a step 30 for restoring the damaged areas of the vehicle in accordance with the visual and written instructions provided in the checklist.

In the alternate embodiment, the vehicle body restoration process includes client computer 10A connected to host computer 16.

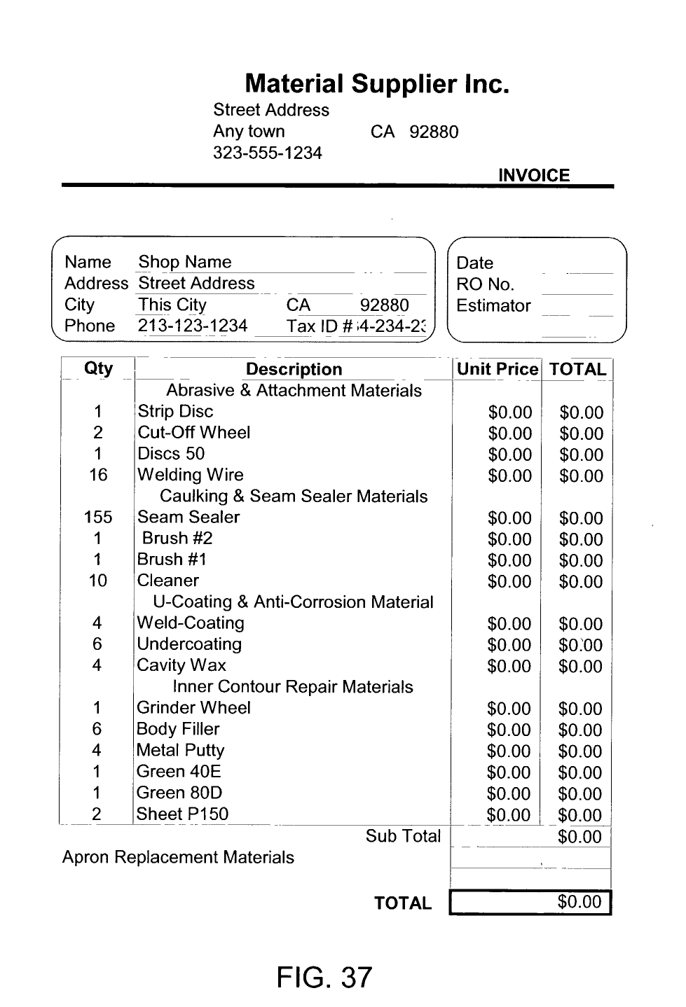

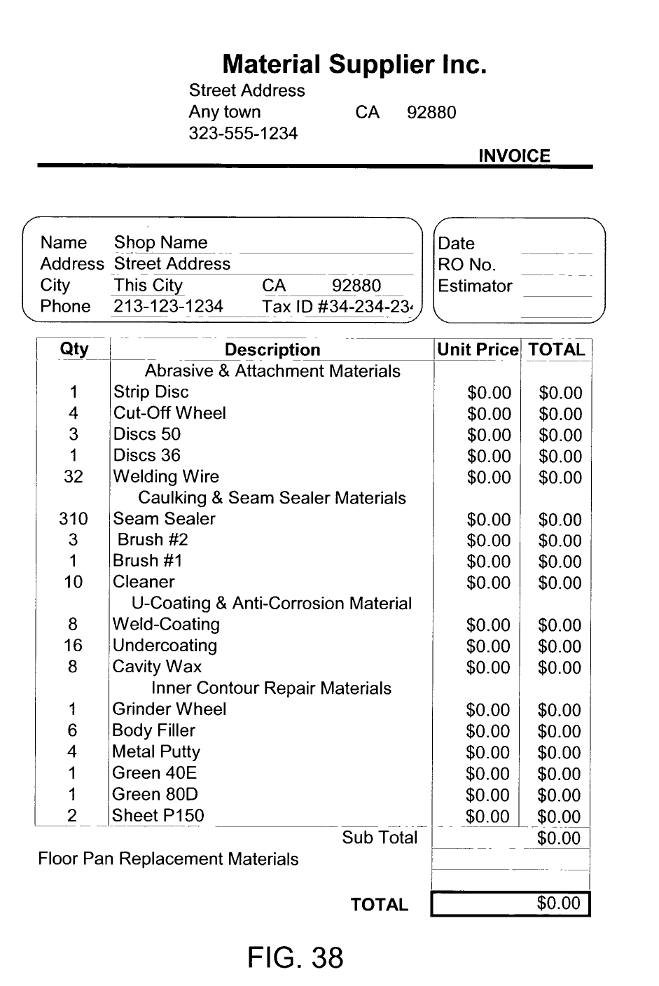

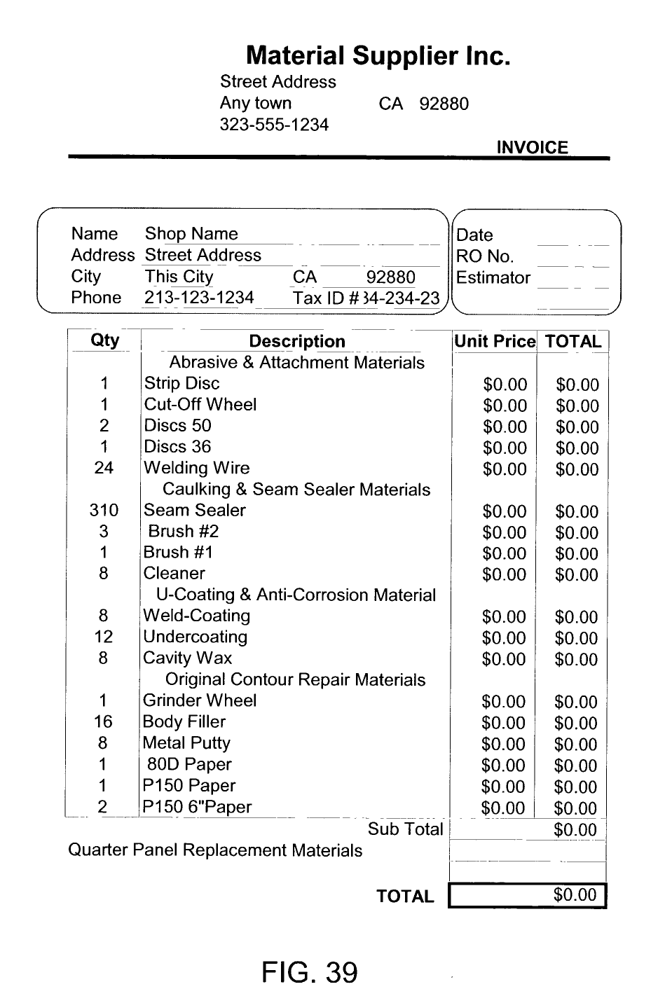

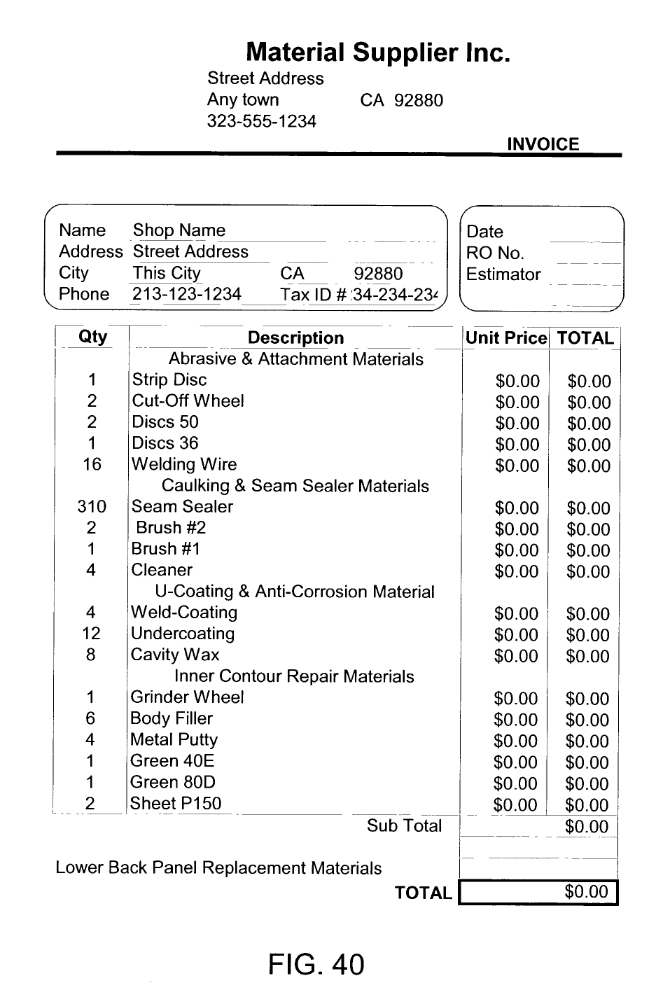

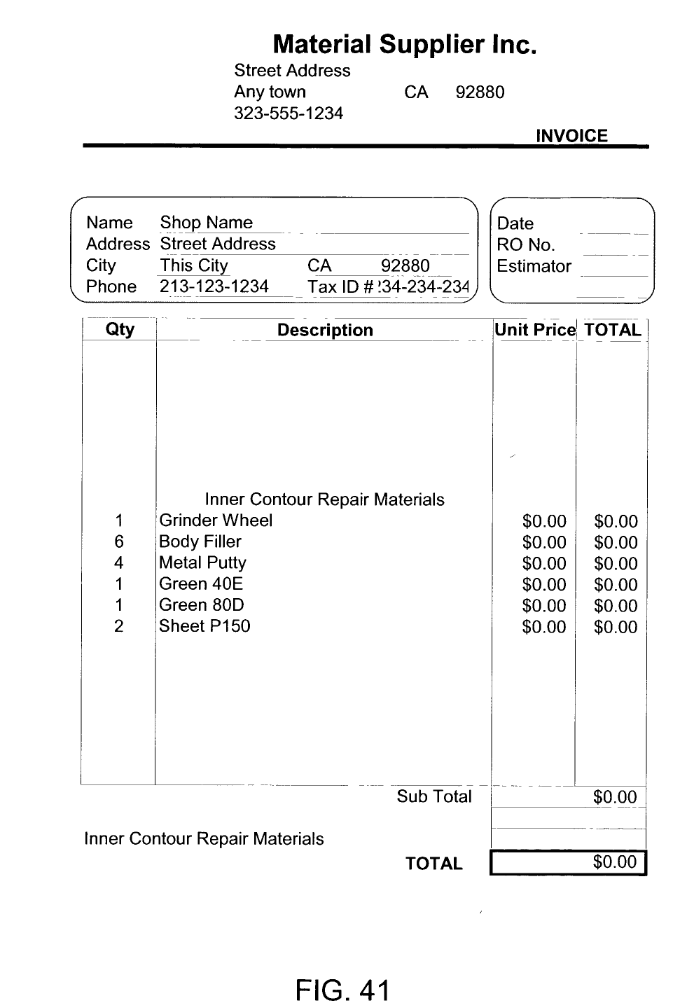

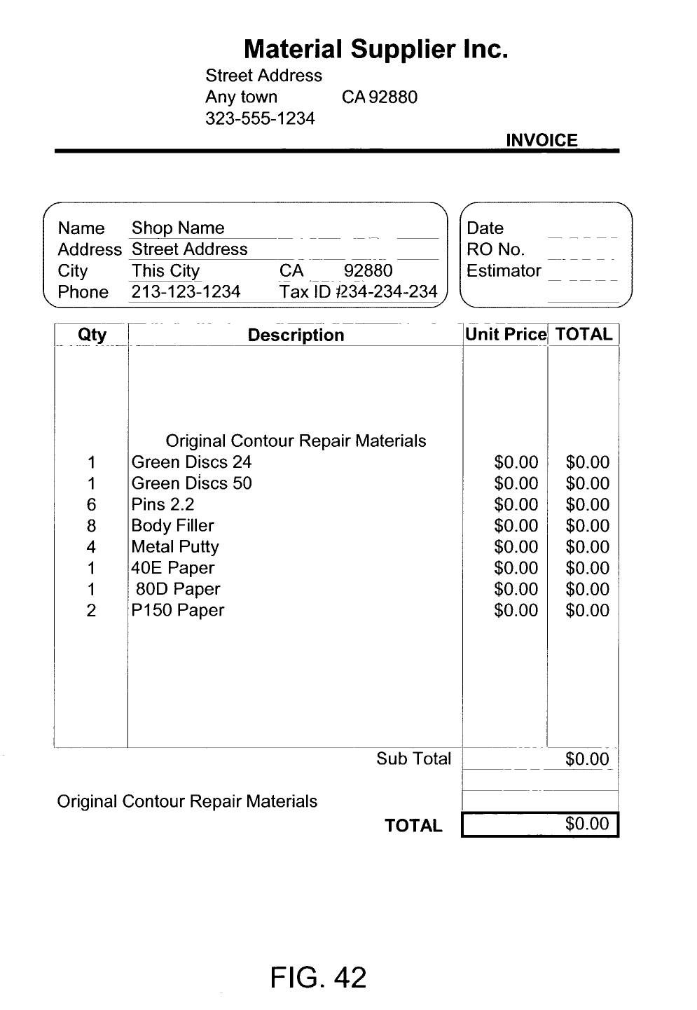

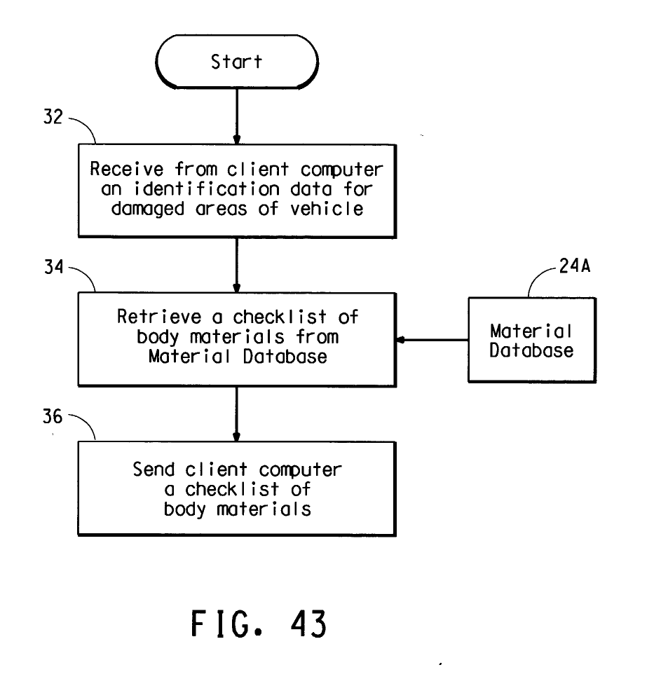

FIG. 43, shows the process, as seen from the host side:

In a step 32, with host computer 16, which is in communication with client computer 10A, receives an identification data for damaged areas of a vehicle from client computer 10A. As stated earlier, the identification data is based on the damage report.

In a step 34, host computer 16 retrieves a checklist on one more body materials required for restoring the damaged areas from a material database 24A stored in host computer 16.

In a step 36, host computer 16 sends to client computer 10A the checklist on one or more body materials required for restoring said damaged areas. It is understood that the aforedescribed embodiment also includes a process whereby client computer 10A accesses host computer 16 via a website.

The process of the alternate embodiment, as seen from the client side, is similar to the one described above for a stand-alone computer 10, except the vehicle body restoration guide is stored on host computer 16. Alternatively, it is understood that the aforedescribed embodiment also includes a process where client computer 10A can download the vehicle body restoration guide from the host computer 16 into client computer 10A. Furthermore, the data, such as the list described earlier can be stored either on client computer 10A, host computer 16, or both.

The present invention also includes computer program product for a stand-alone computer or a client side computer. The computer program includes:

a computer usable medium having computer readable program code means embodied therein for causing restoration of a vehicle body, the computer readable program code means comprising:

(a) computer readable program code devices configured to cause computer 10 or 10A to enter an identification data for damaged areas of the vehicle body on computer 10 or 10A wherein the identification data is based on a damage report;

(b) computer readable program code devices configured to cause computer 10 to retrieve a checklist from a material database on one or more body materials required for restoring the damaged areas; and

(c) computer readable program code devices configured to cause computer 10 or 10A to generate a list of the body materials.

The present invention also includes computer program product for a host side computer. The computer program includes:

a computer usable medium having computer readable program code means embodied therein for causing restoration of a vehicle body, the computer readable program code means comprising:

(a) computer readable program code devices configured to cause host computer 16 to receive from client computer 10A an identification data for damaged areas of a vehicle, client computer 10A being in communication with host computer 16 wherein the identification data is based on a damage report;

(b) computer readable program code devices configured to cause host computer 16 to retrieve a checklist from a material database 24A stored on host computer 16 on one or more body materials required for restoring said damaged areas; and

(c) computer readable program code devices configured to cause host computer 16 to send to client computer 10A said checklist required for restoring said damaged areas.

The vehicle body restoration guide of the present invention can be also used for training and certification programs for body repair technicians. As stated earlier, the vehicle body restoration guide can be used as an audit tool for governmental and or insurance company inspectors charged with verifying the quality of a vehicle restoration job.

1. A vehicle body restoration process comprising:
(a) entering an identification data for damaged areas of a vehicle listed in a guide on a computer wherein said identification data is based on a damage report prepared by an adjuster from an auto insurance company;
(b) retrieving a checklist from a material database on one or more body materials and visual instructions required for restoring said damaged areas, said body materials comprise abrasive & attachment; undercoating & anti-corrosion; caulking & seam; and inner & outer contour portion repair materials;
(c) utilizing said body materials and said visual instructions from said checklist in restoring said damaged areas; and
(d) generating a list of said body materials.

2. The process of claim 1 wherein said damaged area comprises a side member, pillar, radiator support, apron, floor pan, quarter panel, lower back panel, inner and outer contoured portions of said vehicle.

3. (canceled)

4. The process of claim 1 wherein said checklist comprises quantity, cost and manufacturer of said body materials.

5. The process of claim 1 wherein said material database resides on a CD-ROM loaded into said computer or on a hard drive of said computer.

6. The process of claim 1 wherein said list is an invoice.

7. The process of claim 1 further comprising printing said list on a printable sheet.

8. The process of claim 1 further comprising restoring said damaged areas of said vehicle.

9. The process of claim 8 wherein said checklist comprises visual instructions suitable for carrying out said restoring step.

10. The process of claim 9 wherein said checklist is displayed on a screen of said computer.

11. The process of claim 8 wherein said list further comprises identity of technician, number of labor units used in said restoring step.

12. The process of claim 1 wherein said damaged report is produced by accessing an estimator database comprising said damaged areas identified by make, year and model number of said vehicle.

13. The process of claim 12 wherein said damaged report includes estimated labor units needed for restoring said damaged areas.

14. The process of claim 13 further comprising storing said damaged report for future use.

15. The process of claim 1 wherein said vehicle is an automobile, truck, tractor, motorcycle, trailer, ATV, pick-up truck or a heavy mover.

16. A vehicle body restoration process comprising:
(a) entering an identification data for damaged areas of a vehicle listed in a guide on a client computer in communication with a host computer wherein said identification data is based on a damage report prepared by an adjuster from an auto insurance company;
(b) retrieving a checklist from a material database on one or more body materials and visual instructions required for restoring said damaged areas, said body materials comprise abrasive & attachment; undercoating & anti-corrosion; caulking & seam; and inner & outer contour portion repair materials;
(c) utilizing said body materials and said visual instructions from said checklist in restoring said damaged areas; and
(d) generating a list of said body materials.

17. The process of claim 16 wherein said material database resides on a CD-ROM loaded into said host computer.

18. A vehicle body restoration process comprising:
(a) receiving from a client computer an identification data for damaged areas of a vehicle listed in a guide, said client computer being in communication with a host computer wherein said identification data is based on a damage report prepared by an adjuster from an auto insurance company;
(b) retrieving a checklist from a material database stored on said host computer on one or more body materials and visual instructions required for restoring said damaged areas, said body materials comprise abrasive & attachment; undercoating & anti-corrosion; caulking & seam; and inner & outer contour portion repair materials; and
(c) sending to said client computer said checklist required for restoring said damaged areas.

19. A computer program product comprising:
a computer usable medium having computer readable program code means embodied therein for causing restoration of a vehicle body, said computer readable program code means comprising:
(a) computer readable program code devices configured to cause a computer to enter an identification data for damaged areas of said vehicle body listed in a guide on said computer wherein said identification data is based on a damage report prepared by an adjuster from an auto insurance company;
(b) computer readable program code devices configured to cause said computer to retrieve a checklist from a material database on one or more body materials and visual instructions required for restoring said damaged areas, said body materials comprise abrasive & attachment; undercoating & anti-corrosion; caulking & seam; and inner & outer contour portion repair materials; and
(c) computer readable program code devices configured to cause said computer to generate a list of said body materials and said visual instructions from said checklist.

20. The computer product of claim 19 wherein said damaged area comprises a side member, pillar, radiator support, apron, floor pan, quarter panel, lower back panel, inner and outer contoured portions of said vehicle.

21. (canceled)

22. The computer product of claim 19 wherein said checklist comprises quantity, cost and manufacturer of said component.

23. A computer program product comprising:
a computer usable medium having computer readable program code means embodied therein for causing restoration of a vehicle body, said computer readable program code means comprising:
(a) computer readable program code devices configured to cause a host computer to receive from a client computer an identification data for damaged areas of a vehicle listed in a guide, said client computer being in communication with said host computer wherein said identification data is based on a damage report prepared by an adjuster from an auto insurance company;
(b) computer readable program code devices configured to cause said host computer to retrieve a checklist from a material database stored on said host computer on one or more body materials and visual instructions required for restoring said damaged areas, said body materials comprise abrasive & attachment; undercoating & anti-corrosion; caulking & seam; and inner & outer contour portion repair materials; and
(c) computer readable program code devices configured to cause said host computer to send to said client computer said checklist required for restoring said damaged areas.
